(19) United States
(12) Patent Application Publication
(10) Pub. No.: US 2019/0090470 A1
(43) Pub. Date: Mar. 28, 2019

(54) INSECT TRAP

(71) Applicant: Seoul Viosys Co., Ltd., Ansan-si (KR)

(72) Inventors: Gwang Ryong LEE, Ansan-si (KR); Sang Hyun Chang, Ansan-si (KR)

(21) Appl. No.: 16/145,451

(22) Filed: Sep. 28, 2018

(30) Foreign Application Priority Data
Sep. 28, 2017 (KR) 10-2017-0125667

(51) Int. Cl. A01M 1/08; A01M 1/10; A01M 1/20

(52) U.S. Cl. CPC A01M 1/08; A01M 1/06; A01M 1/20; A01M 1/106

(57) ABSTRACT

An insect trap including a light source part to emit a light, a fan disposed under the light source part, a housing to accommodate the fan, and a trapping part disposed under the fan and coupled to the housing. The trapping part includes a trapping net including an opening facing the fan, a body frame coupled to the trapping net, at least one first rib crossing the body frame, and a shutter part coupled to the body frame to be spaced apart from the first rib and opened or closed depending on an operation of the fan.

### CROSS-REFERENCE TO RELATED APPLICATION

This application claims priority from and the benefit of Korean Patent Application No. 10-2017-0125667, filed on Sep. 28, 2017, which is hereby incorporated by reference for all purposes as if fully set forth herein.

### BACKGROUND

### Field

Exemplary embodiments of the invention relate generally to an insect trap and, more specifically, to an insect trap attracting and trapping insects using a light source.

### Discussion of the Background

In general, flying pests, such as flies, mosquitoes, and moths, are potential vectors of infectious diseases and have the potential to cause a lot of damage, directly or indirectly, to humans or crops.

Various agricultural pesticides or insecticides are mainly used to eliminate the pests. However, agricultural pesticides and insecticides can be toxic to human health and contribute to ecosystem imbalance. As alternatives, various methods, such as development of biodegradable insecticides, pest controls using sexual attractant pheromones or enemies, and an attract-and-kill strategy, have been researched.

The above information disclosed in this Background section is only for understanding of the background of the inventive concepts, and, therefore, it may contain information that does not constitute prior art.

### SUMMARY

Exemplary embodiments of the present invention provide an insect trap having a high trapping efficiency.

Additional features of the inventive concepts will be set forth in the description which follows, and in part will be apparent from the description, or may be learned by practice of the inventive concepts.

An exemplary embodiment of the present invention provides an insect trap including a light source part to emit a light, a fan disposed under the light source part, a housing to accommodate the fan, and a trapping part disposed under the fan and coupled to the housing. The trapping part includes a trapping net including an opening facing the fan, a body frame coupled to the trapping net, at least one first rib crossing the body frame, and a shutter part coupled to the body frame to be spaced apart from the first rib and opened or closed depending on an operation of the fan.

The housing may have a cylindrical shape extending in a first direction.

The first rib may have a first width in the first direction and extend in a second direction substantially perpendicular to the first direction.

The insect trap may further include at least one second rib having a second width in the first direction and extending in a third direction crossing the second direction.

The second direction may be substantially vertical to the third direction.

The first width may be equal to the second width, or the second width may be greater than the first width.

The body frame may have a circular shape when viewed in a plan view, and the second rib may have a concentric shape with a radius different from that of the body frame.

The shutter part may include a first rotating rod crossing the body frame, a second rotating rod crossing the body frame, a first shutter coupled to the first rotating rod and having a plate shape, a second shutter coupled to the second rotating rod and having a plate shape, a first weight disposed at one side portion of the first shutter, and a second weight disposed at one side portion of the second shutter. The first and second shutters may be independently rotated about the first and second rotating rods, respectively.

A longitudinal direction of the first and second rotating rods may correspond to the second direction.

Each of the first and second shutters may include a main wing and a sub-wing, which face each other with the first rotating rod disposed therebetween, and each of the first and second weights may be coupled to the sub-wing.

The sub-wing of the first and second shutters may be spaced apart from the first rib. The main wing makes contact with the second rib when the fan is not operated. The sub-wing is substantially parallel to the first direction and faces the fan when the fan is not operated.

The first and second shutters are closed when the fan is not operated and opened at an inclined angle when the fan is operated.

The trapping part further may include at least one limiter protruded from an inner circumferential surface of the body frame to restrict a movement of the first and second shutters.

Each of the first and second rotating rods may include a step jaw protruded therefrom, and the body frame may include a rotation limiter to restrict a rotation of the step jaw.

The insect trap further may include a cover coupled to the housing to cover the light source part.

The insect trap may further include an insecticide dispenser provided on at least one of the light source part, the housing, the cover, the fan, and the trapping net to spray an insecticide.

The insect trap may further include a heater provided on at least one of the light source part, the housing, the cover, the fan, and the trapping net to radiate a heat.

The body frame may include a first coupling part to be coupled to the trapping net, the first coupling part may be an insertion protrusion protruded from the body frame, and the trapping net may include an insertion recess into which the insertion protrusion is inserted. The body frame may include a second coupling part to be coupled to the housing, the second coupling part may be an insertion protrusion protruded from the body frame, and the housing may include an insertion recess into which the insertion protrusion is inserted. The second coupling part may be a spiral protrusion protruded from the body frame, and the trapping net is rotatably inserted into the housing.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a perspective view showing an insect trap according to an exemplary embodiment of the present invention.

FIG. 2 is an exploded perspective view showing the insect trap shown in FIG. 1.

FIG. 3A is an exploded perspective view showing a light source part according to an exemplary embodiment of the present invention.

FIGS. 3B and 3C are cross-sectional views showing a light source device of FIG. 3A.

FIG. 4 is an exploded perspective view showing an air blowing part according to an exemplary embodiment of the present invention.

FIG. 5 is an exploded perspective view showing a trapping part according to an exemplary embodiment of the present invention.

FIG. 6A is a perspective view showing a trapping net cover in a closed state according to an exemplary embodiment of the present invention.

FIG. 6B is a partial perspective view taken along a line I-I′ of FIG. 6A.

FIG. 6C is a cross-sectional view taken along a line I-I′ of FIG. 6A.

FIG. 7A is a perspective view showing a trapping net cover in an opened state according to an exemplary embodiment of the present invention;

FIG. 7B is a partial perspective view taken along a line II-IF of FIG. 7A.

FIG. 7C is a cross-sectional view taken along a line II-IF of FIG. 7A.

FIG. 8 is a partial perspective view showing a cross-section of an insect trap according to another exemplary embodiment of the present invention.

FIG. 9 is a partial perspective view showing a cross-section of an insect trap according to another exemplary embodiment of the present invention.

FIG. 10 and FIG. 11 are partial perspective views showing a cross-section of insect traps according to another exemplary embodiment of the present invention.

FIG. 12 is a plan view showing an insect trap employing a structure that controls a rotation angle of a rotating rod rather than a shutter according to an exemplary embodiment of the present invention;

FIG. 13A is a perspective view showing a trapping net cover of which a shutter is in an opened state.

FIG. 13B is a perspective view showing a trapping net cover of which a shutter is in a closed state.

### DETAILED DESCRIPTION

In the following description, for the purposes of explanation, numerous specific details are set forth in order to provide a thorough understanding of various exemplary embodiments of the invention. As used herein “embodiments” are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z—axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

An insect trap according to an exemplary embodiment of the present invention is used to trap insects outdoors. However, locations of the insect trap should not be limited to the outdoors and may be located indoors. In the case where the insect trap is located indoors, the insect trap may be placed at various locations, such as ceilings, walls, or floors.

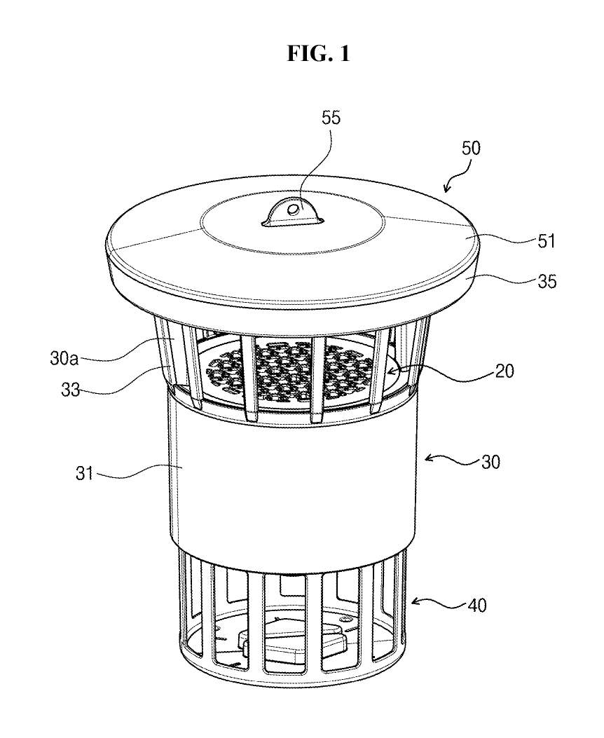

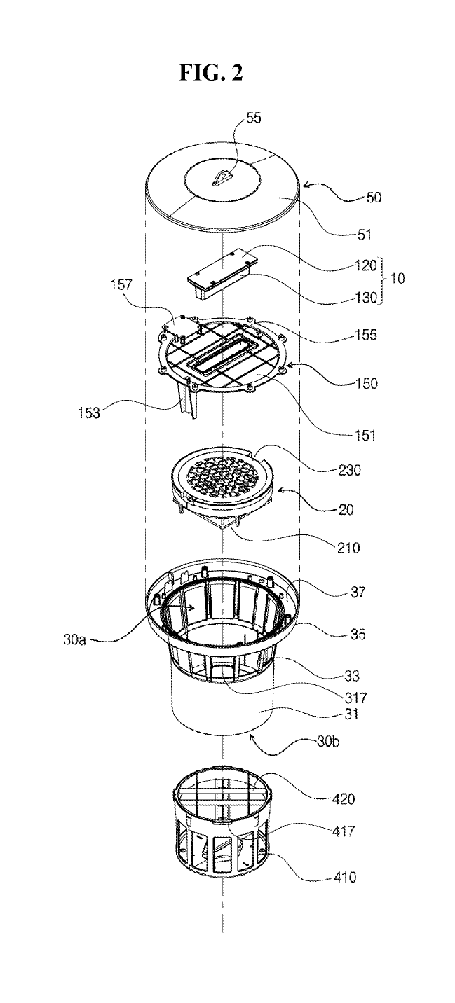

FIG. 1 is a perspective view showing an insect trap according to an exemplary embodiment of the present invention, and FIG. 2 is an exploded perspective view showing the insect trap shown in FIG. 1. Hereinafter, for the convenience of explanation, some components (e.g., a mesh portion of a trapping part) of the insect trap will be omitted.

Referring to FIGS. 1 and 2, the insect trap according to the exemplary embodiment of the present invention includes a housing 30 forming an exterior of the insect trap, a cover 50 covering one side of the housing 30, a light source part 10 accommodated in the housing 30 and emitting a light for attracting insects, an air blowing part 20 disposed adjacent to the light source part 10, and a trapping part 40 disposed adjacent to the air blowing part 20 and capable of being coupled to the housing 30. The light source part 10 may be supported by a light source support part 150 coupled to the cover 50.

The housing 30 forms the exterior of the insect trap and has a cylindrical shape extending vertically. The shape of the housing 30 should not be limited in the inventive concepts to a cylindrical shape in which both ends are opened, and may have various shapes by taking into account a use of the insect trap, a type of the insect trap, and a type of insect to catch. Hereinafter, the housing 30 having the cylindrical shape extending vertically will be described as a representative example.

The housing 30 has an inner space in which the light source part 10 and the air blowing part 20 are accommodated and both ends of the housing 30 are opened. Air is introduced into the inner space through an opening defined at an upper end of the both ends. The air is discharged to the outside of the housing 30 from the inner space through an opening defined at a lower end of the both ends after passing through the trapping part 40.

The housing 30 includes a main body 31 having a pipe shape, posts 33 connected to and disposed above the main body 31 to provide an air inlet 30a through which the insects enter, and a coupling part 35 disposed on the posts 33 and coupled to the cover 50. One end of the housing 30 is coupled to the cover 50, and the air inlet 30a is provided at a side surface of the housing 30. The other end of the housing 30 serves as an air outlet 30b and is connected to the trapping part 40.

The main body 31 accommodates the air blowing part 20 therein, and the trapping part 40 is coupled to a lower portion of the main body 31. The main body 31, extends in a vertical direction. Hereinafter, for the convenience of explanation, the vertical direction will be referred to as a “first direction” with respect to the extending direction of the main body 31. In particular, a direction toward the light source part 10 from the main body 31 will be referred to as an “upward direction” or “upward”; a direction toward the trapping part 40 from the main body 31 will be referred to as a “downward direction” or “downward”; and a direction perpendicular to the vertical direction will be referred to as a “horizontal direction”. However, the terms for the directions used herein are for the convenience of explanation and may be interpreted as a different direction depending on the rotation or placement of the device.

The posts 33 are provided in plural number and connected to an upper portion of the main body 31 in the vertical direction such that the air inlet 30a is formed between the posts 33 adjacent to each other. However, the shape of the posts 33 should not be limited thereto or thereby. That is, the shape of the posts 33 may be changed in various ways as long as the air inlet 30a is secured.

The coupling part 35 is connected to upper portions of the posts 33. The coupling part 35 may have a ring shape corresponding to the shape of the cover 50 and the light source support part 150. The coupling part 35 includes a stepped portion 37 formed thereinside. The stepped portion 37 is coupled to the light source support part 150.

Accordingly, the posts 33 may be provided in a manner to maximize the air inlet 30a, and simultaneously may stably support the main body 31, the cover 50, and the light source support part 150.

In an exemplary embodiment of the present invention, the main body 31, the posts 33, and the coupling part 35 of the housing 30 may be integrally formed with each other without being separated from each other. According to another exemplary embodiment of the present invention, the main body 31, the posts 33, and/or the coupling part 35 may be provided to be assembled after being manufactured individually.

According to an exemplary embodiment of the present invention, the insects may enter the inner space of the housing 30 through the air inlet 30a provided on the side surface of the housing 30. The shape and size of the air inlet 30a may be changed in various ways by taking into account the type, size, and flight form of the insects to be attracted, and particularly, the air inlet 30a may have the shape and size that allows the light from the light source part 10 to exit as much as possible to the outside of the insect trap.

The cover 50 is mounted on one end of an upper portion of the housing 30. The shape of the cover 50 should not be particularly limited and may be manufactured according to the shape of the housing 30. The cover 50 may be provided to be attachable to and detachable from the upper portion of the housing 30.

The cover 50 entirely covers the upper portion of the housing 30. The cover 50 includes a cover main body 51 having a substantially plate shape, and the cover main body 51 may have a stepped portion as needed. An edge of the cover 50 may extend downward and may face the coupling part 35 of the housing 30. The cover 50 and the coupling part 35 of the housing 30 may be fixed to each other by one or more coupling members. Examples of the coupling members may include a hook, a screw, an insertion recess, a protrusion, or the like, and the cover 50 and the coupling part 35 of the housing 30 may be coupled to each other in various ways.

A ring 55 may be installed at the upper portion of the cover main body 51 of the cover 50 to fix the insect trap.

The light source support part 150 corresponds to a component on which the light source part 10 is mounted and stably holds the light source part 10 in the insect trap. The light source support part 150 is provided between the air inlet 30a and the cover 50.

The light source support part 150 may include a plate 151 having a circular shape and assembled with the housing 30 in a direction perpendicular to a longitudinal direction of the housing 30 and a supporting stand 153 protruded downward from the plate 151. The supporting stand 153 may be provided in plural number and connected to the main body 31 of the housing 30 to allow the light source support part 150 to be stably fixed to the main body 31. In an exemplary embodiment of the present invention, two supporting stands 153 may be provided.

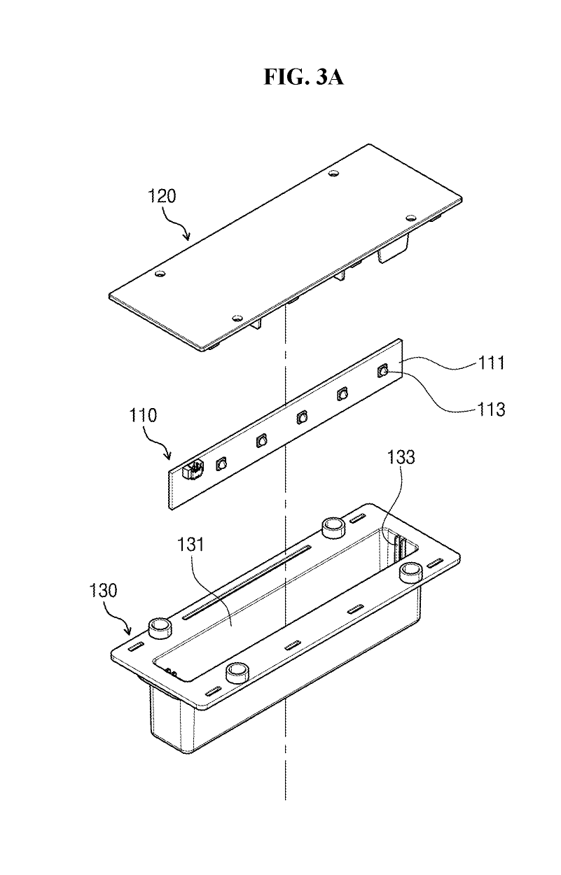

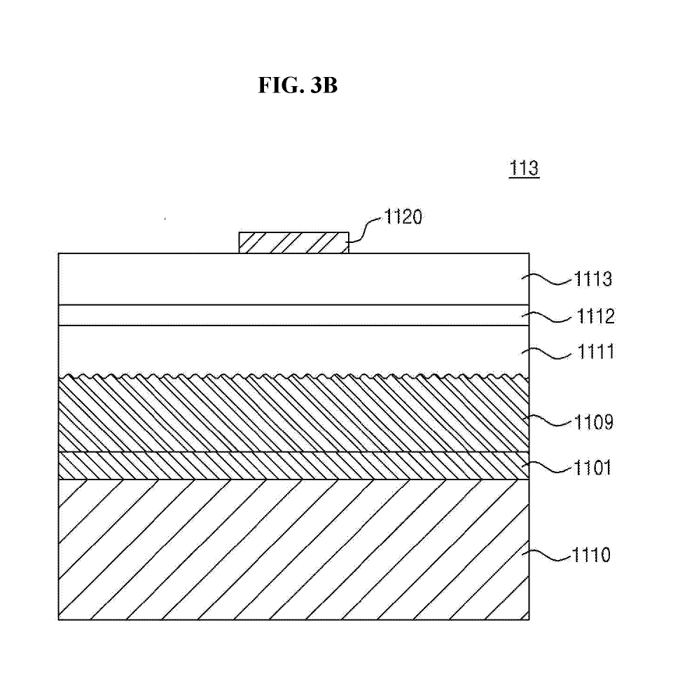

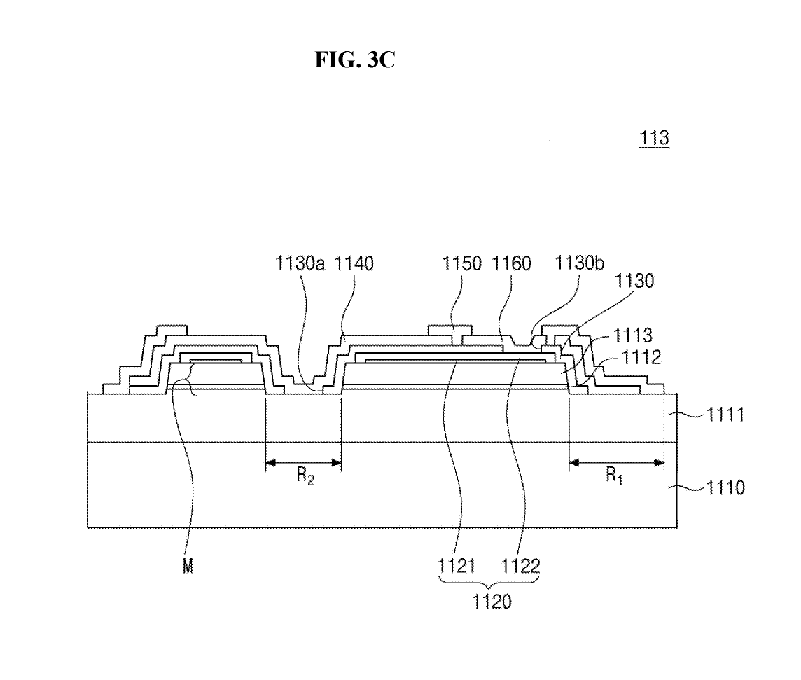

A driving printed circuit board 157 on which a driver that drives the light source part 10 is mounted may be provided at one side portion of an upper surface of the plate 151 on the light source support part 150. The driving printed circuit board 157 may be connected to a light source unit 110 (refer to FIG. 3A) of the light source part 10 by wirings (not shown). In detail, the driving printed circuit board 157 may be connected to each light source through a connector of the light source unit 110. In addition, the driver is electrically connected to the air blowing part 20 through wirings thereunder to control a fan 220 of the air blowing part 20, and thus, an air-blowing amount may be controlled. The air blowing part 20 and the driver are connected to each other through a wiring inlet/outlet.

In an exemplary embodiment of the present invention, a photocatalyst layer including a photocatalytic material may be provided on a rear surface of the light source support part 150. Examples of the photocatalytic material include titanium oxide (TiO₂), zinc oxide (ZnO), tin oxide (SnO₂), and the like, which cause a catalytic reaction with respect to the light irradiated from the light source part 10. The photocatalyst layer may be formed on a surface of the light source support part 150 as a separate layer, or may be included in a material for the light source support part 150 when the light source support part 150 is manufactured.

The photocatalyst may react to light at various wavelength bands depending on a material for the photocatalyst. In an exemplary embodiment of the present invention, a material that causes a photocatalytic reaction with respect to a light at an ultraviolet wavelength band among the lights at various wavelength bands may be used. However, the type of the photocatalyst should not be limited thereto or thereby, and other photocatalysts having the same or similar mechanism in accordance with the light emitted from the light source part 10 may be used. The photocatalyst is activated by an ultraviolet ray to cause a chemical reaction, and various contaminants and germs in the air that make contact with the photocatalyst are decomposed by an oxidation-reduction reaction. By using the photocatalytic reaction, the air may be sterilized, purified and deodorized. In particular, in the case of sterilization, enzymes in germ cells and enzymes that act on a respiratory system are destroyed to obtain sterilization or an antimicrobial effect. Thus, reproduction of germs or mold may be prevented and toxins released from the germs or mold may also be degraded.

In an exemplary embodiment of the present invention, the photocatalyst layer may be, but is not limited to, a titanium oxide layer. When the ultraviolet ray is irradiated onto the titanium oxide, carbon dioxide is generated, and effectiveness in attracting the insects may be improved due to the carbon dioxide. An area in which a titanium oxide layer is provided should not be particularly limited as long as the light from the light source part 10 reaches, and the titanium oxide layer may be provided to a portion or all the rear surface of the light source support part 150.

In an exemplary embodiment of the present invention, the titanium oxide layer may be formed not only on the rear surface of the light source support part 150, but also in other areas to which the light reaches. For example, the titanium oxide layer may be formed on an upper surface of the air blowing part 20, e.g., an upper surface of an insect passage part.

In an exemplary embodiment of the present invention, the rear surface of the light source support part 150 may have a degree of roughness sufficient to effectively disperse and/or scatter the light from the light source part 10. An area where the roughness is defined may be a portion or all of the rear surface of the light source support part 150. In addition, in an exemplary embodiment of the present invention, the roughness may be defined in other areas of other components to which the light reaches, in addition to the rear surface of the light source support part 150, to effectively disperse and/or scatter the light. For instance, the roughness may be defined on the upper surface of the air blowing part 20, e.g., an upper surface of the insect passage part and an inner sidewall of the housing 30.

The light source support part 150 is disposed on the stepped portion of the coupling part 35 and coupled to the housing 30 by various coupling members. Examples of the coupling members may include the hook, the screw, the insertion recess, the protrusion, or the like. In an exemplary embodiment of the present invention, the stepped portion of the housing 30 has a hollow circular shape, and the light source support part 150 has the circular shape to overlap with the stepped portion of the housing 30 and is disposed on an opened portion of the stepped portion of the housing 30.

The light source support part 150 is provided with an opening 155 into which the light source part 10 is inserted. The light source part 10 is inserted into the opening 155 along the downward direction, and as a result, the light source part 10 protrudes downward from the rear surface of the light source support part 150.

The light source part 10 emits light having a wavelength at which the insects are attracted. Wavelengths at which the insects are attracted may be different from each other depending on the insects. The light source part 10 emits light having a wavelength at which the insects are attracted, and when the wavelengths at which the insects are attracted are different from each other depending on the insects, the light source part 10 may control the wavelength to selectively trap the insects.

The light source part 10 is inserted into the opening 155 of the light source support part 150. The light source support part 150 and the light source part 10 may be coupled to each other by the hook, the screw, the insertion recess, the protrusion, or the like.

FIG. 3A is an exploded perspective view showing the light source part according to an exemplary embodiment of the present invention, and FIGS. 3B and 3C are cross-sectional views showing the light source device of FIG. 3A.

Referring to FIGS. 1, 2, and 3A, the light source part 10 according to an exemplary embodiment of the present invention includes the light source unit 110 emitting the light to attract the insects, a light source case 130 accommodating the light source unit 110 therein, and a light source cover 120 covering the light source case 130.

In an exemplary embodiment of the present invention, the light source part 10 may be provided in a surface light source form and/or a point light source form and may emit the light to attract the insects. In an exemplary embodiment of the present invention, the light source part 10 may be provided in the point light source form, and hereinafter, the light source part 10 having the point light source will be described as a representative example.

The light source unit 110 includes a substrate 111 and at least one light emitting device 113 mounted on the substrate 111. The substrate 111 may have a plate shape extending in a predetermined direction. At least one light emitting device, for example, plural light emitting devices may be arranged at at least one surface of the substrate 111 along the predetermined direction. In the case where the light emitting device 113 is provided in plural number, the light emitting devices 113 may be arranged in various ways, e.g., a straight line or a zigzag shape.

In a case where the light emitting device 113 is provided in plural number on both surfaces of the substrate 111, the light emitting devices 113 are disposed not to overlap with each other when viewed in a plan view. When the light emitting devices 113 are disposed at different positions on the both surfaces, heat discharge efficiency may be improved. However, the arrangement of the light emitting device 113 should not be limited thereto or thereby and may be changed in various ways.

The light emitting device 113 may emit light in an ultraviolet wavelength band. Here, the light emitting device 113 may emit the light in a wavelength band preferred by the insects, for example, the light in the ultraviolet wavelength band. In the case where the light in the ultraviolet wavelength band is emitted from the light emitting device 113, the wavelength of the light may be within a range from about 320 nm to about 400 nm. In the case where the light emitting device 113 is provided in plural number, the light emitting devices 113 may emit the lights at the same wavelength band as each other or different wavelength bands from each other. For instance, in the exemplary embodiment, all the light emitting devices 113 may emit the light at the ultraviolet wavelength band. According to another exemplary embodiment, some light emitting devices 113 may emit the light in a portion of the ultraviolet wavelength band, and the other light emitting devices 113 may emit the light in the other portion of the ultraviolet wavelength band. As an example, some light emitting devices 113 may emit the light in the wavelength band from about 320 nm to about 400 nm, and the other light emitting devices 113 may emit the light in the wavelength band different from the wavelength band from about 320 nm to about 400 nm. When the light emitting device 113 has different wavelength bands from each other, the light emitting device 113 may be arranged in various orders.

In an exemplary embodiment of the present invention, each light emitting device 113 may further emit light in a wavelength band that sterilizes or immobilizes the insects or germs in addition to the light at the wavelength band that attracts the insects. According to an exemplary embodiment of the present invention, since the insects are trapped in the insect trap, the light with sterilization function may be added to minimize the growth of germs caused by dead insects. As an example, the light emitting device 113 may emit the light in the wavelength band from about 100 nm to about 280 nm, which corresponds to an ultraviolet C wavelength band.

However, the wavelength band of the light emitted from the light emitting device 113 should not be limited to the above mentioned range. According to other exemplary embodiments, the light emitting device 113 may emit not only the light in the ultraviolet wavelength band but also a light at a visible light wavelength band. For instance, according to the wavelength at which the insects are attracted, flies and brown planthoppers are known to be attracted to light in the wavelength of about 340 nm to about 575 nm, and moths and mosquitoes are known to be attracted to light at the wavelength of about 366 nm. In addition, it is known that different insects are attracted to light with different colors in visible light wavelength band, e.g., a white, yellow, red, green, or blue color. Further, lights at other various wavelengths that are not described in the above-mentioned exemplary embodiments may be applied to attract the insects as long as the light stimulates insects' sight sufficient to attract the insects.

In an exemplary embodiment of the present invention, the light emitting device 113 may emit light in a specific wavelength band and should not be particularly limited, and the light emitting device 113 may be a light emitting diode (LED).

FIGS. 3B and 3C are cross-sectional views showing an example of the light source device 113 of FIG. 3A. In detail, FIGS. 3B and 3C show the light emitting device 113 implemented by the light emitting diode. The light emitting diode may have various forms, e.g., a vertical-type light emitting diode or a flip-type light emitting diode. FIG. 3B shows the vertical-type light emitting diode, and FIG. 3C shows the flip-type light emitting diode. However, the form of the light emitting diode should not be limited thereto or thereby, and the following drawings are to be understood as one exemplary embodiment of the present invention.

Referring to FIG. 3B, the light emitting diode 113 includes a first conductive type semiconductor layer 1111, an active layer 1112, and a second conductive type semiconductor layer 1113. A light source substrate 1110 that serves as a first electrode, an adhesive layer 1101, and a reflective layer 1109 are disposed under the first conductive type semiconductor layer 1111, and a second electrode 1120 is disposed on the second conductive type semiconductor layer 1113.

The light source substrate 1110 may include a conductive material, such as Si, GaAs, GaP, AlGaINP, Ge, SiSe, GaN, AlInGaN, or InGaN. The light source substrate 1110 also may include a single metal, such as Al, Zn, Ag, W, Ti, Ni, Au, Mo, Pt, Pd, Cu, Cr, Fe, or an alloy thereof.

The second conductive type semiconductor layer 1113 may be disposed on the first conductive type semiconductor layer 1111, and the active layer 1112 may be disposed between the first conductive type semiconductor layer 1111 and the second conductive type semiconductor layer 1113. The first conductive type semiconductor layer 1111, the active layer 1112, and the second conductive type semiconductor layer 1113 may include a III-V compound semiconductor, for example, a nitride-based semiconductor such as (Al, Ga, In)N. The first conductive type semiconductor layer 1111 may include a first conductive type impurity, e.g., Si, and the second conductive type semiconductor layer 1113 may include a second conductive type impurity, e.g., Mg, or vice versa.

In an exemplary embodiment of the present invention, the first conductive type semiconductor layer 1111 may be subjected to a roughening treatment. Accordingly, light generated from the active layer 1112 may be reflected by the roughened surface.

In an exemplary embodiment of the present invention, the reflective layer 1109 may be interposed between the first conductive type semiconductor layer 1111 and the light source substrate 1110. The reflective layer 1109 may include a metal material with high reflectivity, e.g., silver (Ag) or aluminum (Al), and may include other metal materials with high reflectivity or alloys thereof.

Meanwhile, the adhesive layer 1101 may be interposed between the reflective layer 1109 and the light source substrate 1110, and the adhesive layer 1101 may increase an adhesive force between the reflective layer 1109 and the light source substrate 1110 to prevent the reflective layer 1109 and the light source substrate 1110 from being separated from each other. In addition, although not shown in the figures, a diffusion prevention layer may be interposed between the adhesive layer 1101 and the reflective layer 1109. The diffusion prevention layer prevents metal elements from being diffused to the reflective layer 1109 from the adhesive layer 1101 or the light source substrate 1110 to maintain a reflectivity of the reflective layer 1109.

The second electrode 1120 is disposed on the second conductive type semiconductor layer 1113. Thus, a current may be supplied to the first conductive type semiconductor layer 1111 and the second conductive type semiconductor layer 1113 through the light source substrate 1110 serving as the first electrode and the second electrode 1120, and thus, the light may be emitted.

Referring to FIG. 3C, the light emitting diode 113 may include a mesa M including a first conductive type semiconductor layer 1111, an active layer 1112, and a second conductive type semiconductor layer 1113, a first insulating layer 1130, a first electrode 1140, and a second insulating layer 1150, and may further include a light source substrate 1110 and a second electrode 1120.

The light source substrate 1110 should not be particularly limited as long as the first conductive type semiconductor layer 1111, the active layer 1112, and the second conductive type semiconductor layer 1113 may be grown and may be a sapphire substrate, a silicon carbide substrate, a gallium nitride substrate, a aluminum nitride substrate, or a silicon substrate. The light source substrate 1110 may include an inclined side surface, and thus, an extraction of the light generated from the active layer 1112 may be improved.

The second conductive type semiconductor layer 1113 may be disposed on the first conductive type semiconductor layer 1111, and the active layer 1112 may be disposed between the first conductive type semiconductor layer 1111 and the second conductive type semiconductor layer 1113. The first conductive type semiconductor layer 1111, the active layer 1112, and the second conductive type semiconductor layer 1113 may include a III-V compound semiconductor, for example, a nitride-based semiconductor such as (Al, Ga, In)N. The first conductive type semiconductor layer 1111 may include a first conductive type impurity, e.g., Si, and the second conductive type semiconductor layer 1113 may include a second conductive type impurity, e.g., Mg, or vice versa. The active layer 1112 may have a multiple quantum well structure (MQM). When a forward bias voltage is applied to the light emitting diode 113, electrons are combined with holes in the active layer 1112 to emit the light. The first conductive type semiconductor layer 1111, the active layer 1112, and the second conductive type semiconductor layer 1113 may be grown on the light source substrate 1110 using a metal-organic chemical vapor deposition (MOCVD) or a molecular-beam epitaxy (MBE).

The light emitting diode 113 may include at least one mesa M including the active layer 1112 and the second conductive type semiconductor layer 1113. The mesa M may include a plurality of protrusions spaced apart from each other. In other words, the light emitting diode 113 may include a plurality of mesas M spaced apart from each other. A side surface of the mesa M may be formed at an inclined angle by using a photoresist reflow process, and the inclined side surface of the mesa M may improve a light emitting efficiency of the light generated from the active layer 1112.

The first conductive type semiconductor layer 1111 includes a first contact region R1 and a second contact region R2 defined therein and exposed through the mesa M. Since the mesa M is formed by removing portions of the active layer 1112 and the second conductive type semiconductor layer 1113, which are disposed on the first conductive type semiconductor layer 1111, portions except for the mesa M become the contact regions that are the exposed upper surface of the first conductive type semiconductor layer 1111. The first electrode 1140 makes contact with the first contact region R1 and the second contact region R2, and thus the first electrode 1140 may be electrically connected to the first conductive type semiconductor layer 1111. The first contact region R1 may be disposed around the mesa M along an edge of the first conductive type semiconductor layer 1111, and in detail, the first contact region R1 may be disposed along the edge of the upper surface of the first conductive type semiconductor layer 1111 between the mesa M and the side surface of the light emitting diode 113. The second contact region R2 may be partially surrounded by the mesa M.

The second electrode 1120 may be disposed on the second conductive type semiconductor layer 1113 and electrically connected to the second conductive type semiconductor layer 1113. The second electrode 1120 may be formed on the mesa M and may have the same shape as that of the mesa M. The second electrode 1120 may include a reflective metal layer 1121 and a barrier metal layer 1122, and the barrier metal layer 1122 may cover an upper surface and a side surface of the reflective metal layer 1121. For instance, when a pattern of the reflective metal layer 1121 is formed and the barrier metal layer 1122 is formed on the pattern of the reflective metal layer 1121, the barrier metal layer 1122 may be formed to cover the upper surface and the side surface of the reflective metal layer 1121. As an example, the reflective metal layer 1121 may be formed by depositing and patterning an Ag, Ag alloy, Ni/Ag, NiZn/Ag, TiO/Ag layer.

Meanwhile, the barrier metal layer 1122 may be formed of Ni, Cr, Ti, Pt, Au, or a composition layer thereof. In detail, the barrier metal layer 1122 may be the composition layer of Ni/Ag/[Ni/Ti]₂/Au/Ti that are sequentially formed on the second conductive type semiconductor layer 1113. In more detail, at least a portion of the upper surface of the second electrode 1120 may include a Ti layer with a thickness of about 300 angstroms (Å). In a case where a portion, which makes contact with the first insulating layer 1130, of the upper surface of the second electrode 1120 includes the Ti layer, an adhesive force between the first insulating layer 1130 and the second electrode 1120 may be improved, and thus, a reliability of the light emitting diode 113 may be improved.

An electrode protective layer 1160 may be disposed on the second electrode 1120, and the electrode protective layer 1160 may include the same material as the first electrode 1140, but the inventive concepts should not be limited thereto or thereby.

The first insulating layer 1130 may be disposed between the first electrode 1140 and the mesa M. The first electrode 1140 may be insulated from the mesa M by the first insulating layer 1130, and the first electrode 1140 and the second electrode 1120 may be insulated from each other. The first insulating layer 1130 may partially expose the first contact region R1 and the second contact region R2. In detail, the first insulating layer 1130 may expose the portion of the second contact region R2 through an opening 1130a, and the first insulating layer 1130 covers only a portion of the first contact region R1 between an edge of the first conductive type semiconductor layer 1111 and the mesa M, thereby exposing at least the portion of the first contact region R1.

The first insulating layer 1130 may be disposed above the second contact region R2 along an edge of the second contact region R2. In this case, the first insulating layer 1130 may be disposed more closely adjacent to the mesa M than an area in which the first contact region R1 makes contact with the first electrode 1140.

The first insulating layer 1130 may include an opening 1130b defined therethrough to expose the second electrode 1120. The second electrode 1120 may be electrically connected to a pad or a bump through the opening 1130b.

Although not shown in figures, when viewed in a plan view, the area in which the first contact region R1 makes contact with the first electrode 1140 is disposed along an edge of the upper surface of the first conductive type semiconductor layer 1111. In detail, the area in which the first contact region R1 makes contact with the first electrode 1140 may be disposed adjacent to four side surfaces of the first conductive type semiconductor layer 1111 and may completely surround the mesa M. In this case, since an area in which the first electrode 1140 makes contact with the first conductive type semiconductor layer 1111 increases, a current flowing to the first conductive type semiconductor layer 1111 from the first electrode 1140 may be effectively distributed, and thus, the forward bias voltage may be further reduced.

In an exemplary embodiment of the present invention, the first electrode 1140 and the second electrode 1120 of the light emitting diode 113 may be directly mounted on the substrate 111 or may be mounted on the substrate 111 using the pad.

For example, in the case where the light emitting diode 113 is mounted on the substrate 111 using the pad, two pads may be provided between the light emitting diode 113 and the substrate 111, and the two pads may make contact with the first electrode 1140 and the second electrode 1120, respectively. As an example, the pad may include a solder or a eutectic metal, but the inventive concepts should not be limited thereto or thereby. For instance, gold-tin (AuSn) may be used as the eutectic metal.

As another example, in the case where the light emitting diode 113 is directly mounted on the substrate 111, the first electrode 1140 and the second electrode 1120 of the light emitting diode 113 may be directly bonded to wirings on the substrate 111. In this case, a bonding material may include an adhesive material having a conductive property. For example, the bonding material may include at least one conductive material among silver (Ag), tin (Sn), and Copper (Cu). However, this is merely exemplary, and the bonding material may include various materials having the conductive property.

The light source unit 110 is accommodated in the light source case 130. The light source case 130 protects the substrate 111 and the light emitting devices 113.

The light source case 130 has an inner space 131 whose one side is opened, and the light source unit 110 is accommodated in the inner space 131. In an exemplary embodiment of the present invention, an upper side of the light source case 130 is opened, and the light source unit 110 may be mounted on the light source case 130 in the vertical direction.

A coupling member, to which the substrate 111 of the light source unit 110 is coupled, is provided on an inner wall of the light source case 130. In an exemplary embodiment of the present invention, the light source unit 110 may be slide-coupled to the light source case 130, and in this case, a slit 133 may be provided on the light source case 130 to allow the light source unit 110 to slide.

The light source cover 120 is provided on the light source case 130 to cover the light source unit 110 and the light source case 130.

In the exemplary embodiment of the present invention, the light source cover 120 and the light source case 130 are coupled to each other by a coupling member. An example of the coupling member includes a hook, a screw, an insertion recess, a protrusion, or the like.

In an exemplary embodiment of the present invention, the light source case 130 includes a transparent insulating material, protects the light sources and the substrate 111, and transmits the light emitted from the light sources.

In an exemplary embodiment of the present invention, the shape of the light source case 130 should not be limited thereto or thereby, and the light source case 130 may have various shapes depending on the shape of the insect trap. In addition, in an exemplary embodiment of the present invention, one light source unit 110 has been described, however, the number of the light source units 110 should not be limited to one. That is, two or more light source units 110 may be employed, and the number of the light sources and/or the number of the substrates 111, which are provided to each light source unit 110, may be changed in various ways.

Referring to FIGS. 1 and 2 again, the air blowing part 20 is provided under the light source part 10. The air blowing part 20 moves the air from the air inlet 30a to the air outlet 30b. The air blowing part 20 may be coupled to an inner circumferential surface of the housing 30 by a coupling member. Examples of the coupling member include a hook, a screw, an insertion recess, a protrusion, and the like.

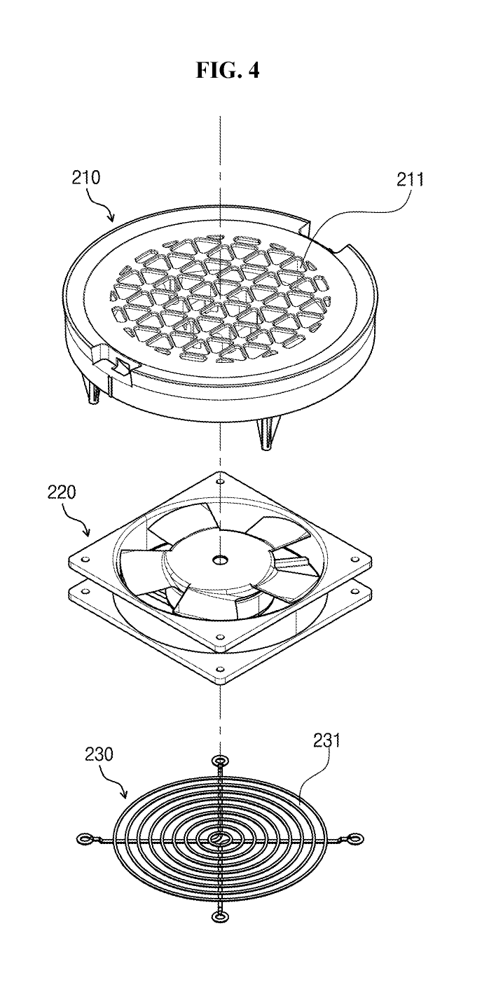

FIG. 4 is an exploded perspective view showing the air blowing part 20 according to an exemplary embodiment of the present invention.

Referring to FIGS. 1, 2, and 4, the air blowing part 20 may include the fan 220 and the insect passage part provided at at least one of upper and lower portions of the fan 220. In an exemplary embodiment of the present invention, the insect passage part may include an upper insect passage part 210 provided at the upper portion of the fan 220 and a lower insect passage part 230 provided at the lower portion of the fan 220.

The upper insect passage part 210 is provided between the light source part 10 and the fan 220, and the lower insect passage part 230 is provided between the fan 220 and the trapping part 40. The upper insect passage part 210 and the lower insect passage part 230 are coupled to each other with the fan 220 disposed therebetween by a coupling member. Examples of the coupling member include a hook, a screw, an insertion recess, a protrusion, and the like, and the upper insect passage part 210, the lower insect passage part 230, and the fan 220 may be coupled to each other by the coupling member in various ways.

The upper insect passage part 210 and the lower insect passage part 230 overlap with the fan 220 when viewed in a plan view. In an exemplary embodiment of the present invention, a diameter of the upper insect passage part 210 and the lower insect passage part 230 may be the same as or greater than a diameter of the fan 220.

The upper insect passage part 210 and the lower insect passage part 230 respectively include thru-holes 211 and 231 through which the air and the insects pass.

The air passes through the thru-holes 211 and 231 by the rotation of the fan 220, and the insects may pass through the thru-holes 211 and 231 up and down due to the flow of the air. A size and a shape of the thru-holes 211 and 231 may be changed in various ways.

The fan 220 includes a motor and a plurality of wings connected to the motor. The wings rotate about a rotational axis of the motor to move the air to the downward direction from the upper portion of the air blowing part 20. When the fan 220 is operated by the motor, the air flowing in through the air inlet 30a of the upper portion of the air blowing part 20 moves to the air outlet 30b of the lower portion of the air blowing part 20. However, the shape of the fan 220 should not be limited thereto or thereby, and various types of fans 220 may be used as long as the fans 220 may move the air.

Referring to FIGS. 1 and 2 again, the trapping part 40 is provided under the insect passage part.

The trapping part 40 traps the insects introduced therein by the air blowing part 20. The trapping part 40 is provided under the air blowing part 20 and mounted on a lower end portion of the housing 30. The trapping part 40 includes a trap-space in which the insects are trapped and an entrance through which the insects are introduced into the trap-space. At least a portion of the trapping part 40 may have a mesh shape such that the air provided from the air blowing part 20 is discharged to the outside.

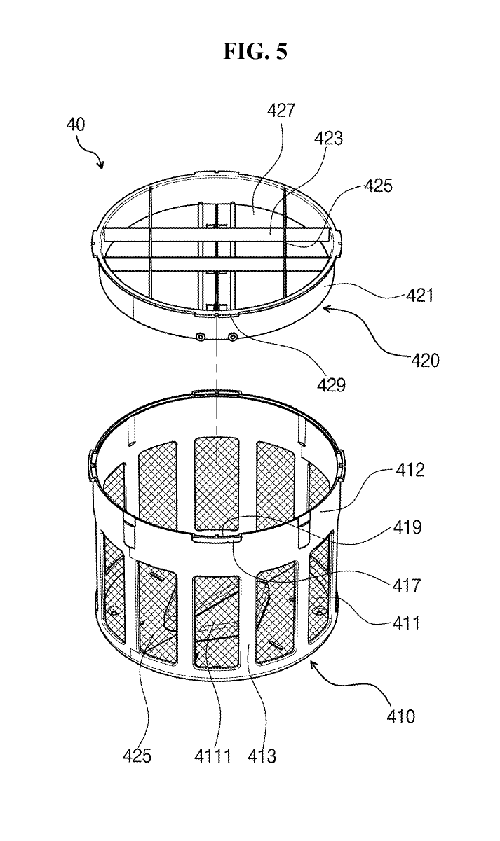

FIG. 5 is an exploded perspective view showing the trapping part 40 according to an exemplary embodiment of the present invention.

Referring to FIG. 5, the trapping part 40 of the insect trap according to an exemplary embodiment of the present invention includes a trapping net 410 and a trapping net cover 420 opening and closing an upper portion of the trapping net 410.

The trapping net 410 has a container shape with an opened top, for example, a cylindrical shape with a closed bottom and an opened top. The trapping net cover 420 is disposed on the opening of the upper portion of the trapping net 410.

The trapping net 410 includes a lower surface part 411 including a grip part 4111 disposed at a lowest portion of the trapping net 410 and gripped by the user, a plurality of posts 413 extending in the upward direction from the lower surface part 411, a mesh part 425 disposed between the posts 413, and an upper ring 412 connected to the posts 413 and having a coupling member to be coupled to the trapping net cover 420 and the housing 30.

The trapping net cover 420 is disposed on the trapping net 410 and covers the upper portion of the trapping net 410.

The trapping net cover 420 includes a shutter part 427 that is opened or closed with the flow of the air and a body frame 421 stably supporting the shutter part 427 disposed thereunder.

The body frame 421 is provided with first ribs 423 and second ribs 425 that prevent the body frame 421 from being deformed and maintains a rigidity of the body frame 421 against internal and external stresses. The second ribs 425 are distinguished from the first ribs 423 due to their extension direction. The trapping net cover 420 will be described in detail with reference to drawings below.

In an exemplary embodiment of the present invention, the trapping net cover 420 is coupled to the trapping net 410 to form the trapping part 40. To this end, the trapping net cover 420 is provided with the coupling member to be coupled to the trapping net 410. The coupling member may be provided in various forms. For example, the hook, the screw, the insertion recess, and the protrusion may be used as the coupling member. In an exemplary embodiment of the present invention, the trapping net cover 420 may include an insertion protrusion 429, and an insertion recess 419 into which the insertion protrusion 429 is inserted may be provided in the upper ring 412 of the trapping net 410.

The entire trapping part 40, i.e., an assembly of the trapping net 410 and the trapping net cover 420, may be attached to or detached from the housing 30. To this end, the coupling member is provided on the trapping net 410 and the housing 30.

The coupling member may be provided in various forms, e.g. the hook, the screw, the insertion recess, and the protrusion. In an exemplary embodiment of the present invention, an insertion protrusion 417 may be provided on a portion of the trapping net 410, for example, on the upper ring 412, and an insertion recess 317 into which the insertion protrusion 417 is inserted may be provided in the inner side surface of the housing 30.

In another exemplary embodiment of the present invention, a spiral protrusion may be formed in the upper ring 412 of the trapping net 410 such that the trapping net 410 is rotationally inserted into the housing 30. A recess corresponding to the spiral protrusion or a protrusion engaged with the spiral protrusion may be provided in the housing 30. In this case, when the trapping net 410 rotates in one direction after disposing the trapping net 410 in the housing 30, the trapping net 410 may be easily coupled to the housing 30. In this case, when the hook is disposed at an end of the spiral protrusion, the trapping net 410 may be stably coupled to the housing 30.

In an exemplary embodiment of the present invention, the coupling structure inside the trapping part 40 and the coupling relation between the trapping part 40 and the housing 30 may be varied within the scope of the present invention. For instance, according to the above exemplary embodiments, the structure that the trapping net 410 is coupled to the trapping net cover 420 and the trapping net 410 is coupled to the housing 30 has been described, however, according to another exemplary embodiment, the trapping net 410 may be coupled to the trapping net cover 420, and the trapping net cover 420 may be coupled to the housing 30.

When the insects are sufficiently trapped in the trapping part 40, the insects may be easily removed from the trapping part 40 by getting rid of the insects from the trapping part 40 after separating the trapping part 40 from the housing 30. The trapping part 40 from which the insects are removed is coupled to the housing 30 again to trap other insects.

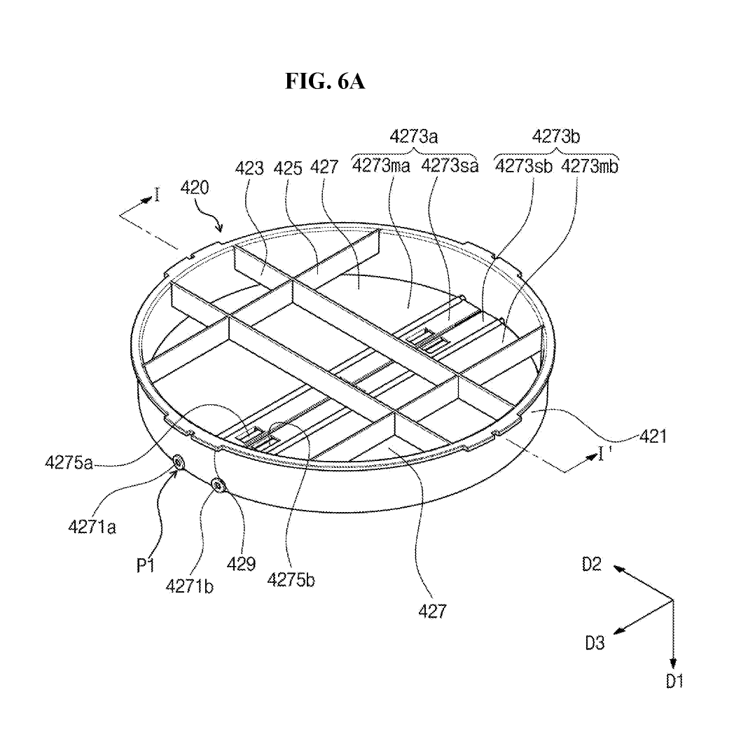

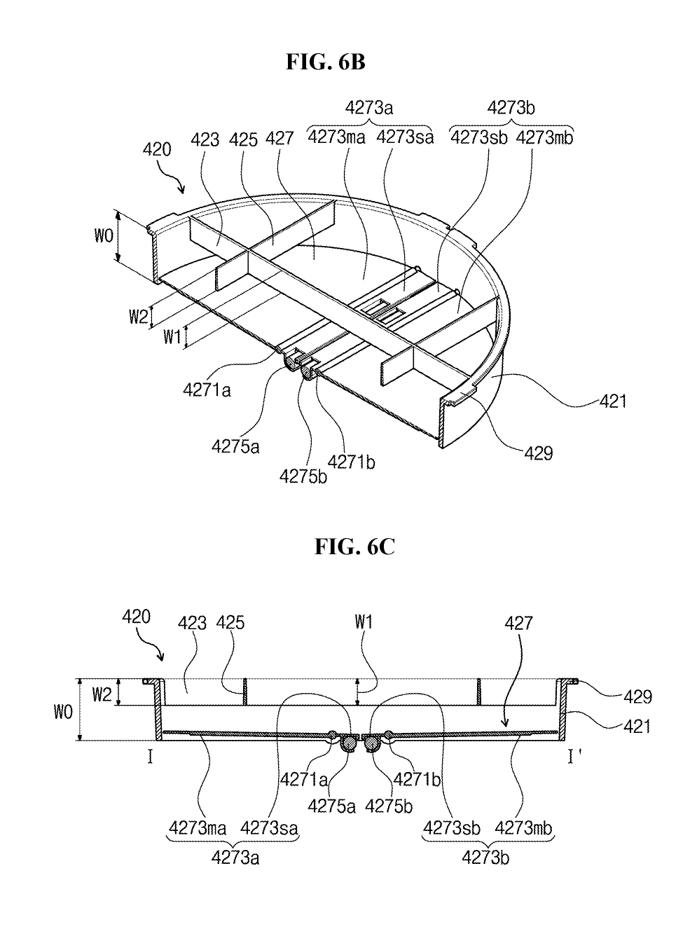

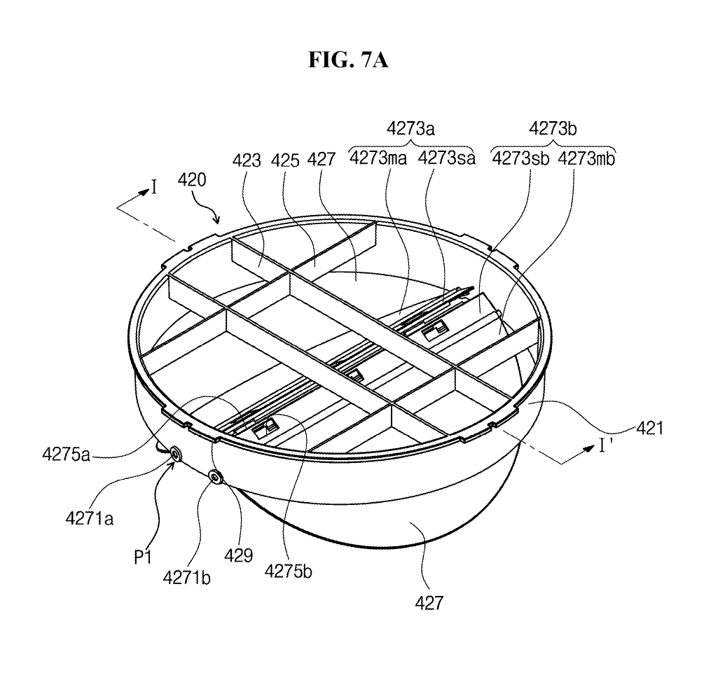

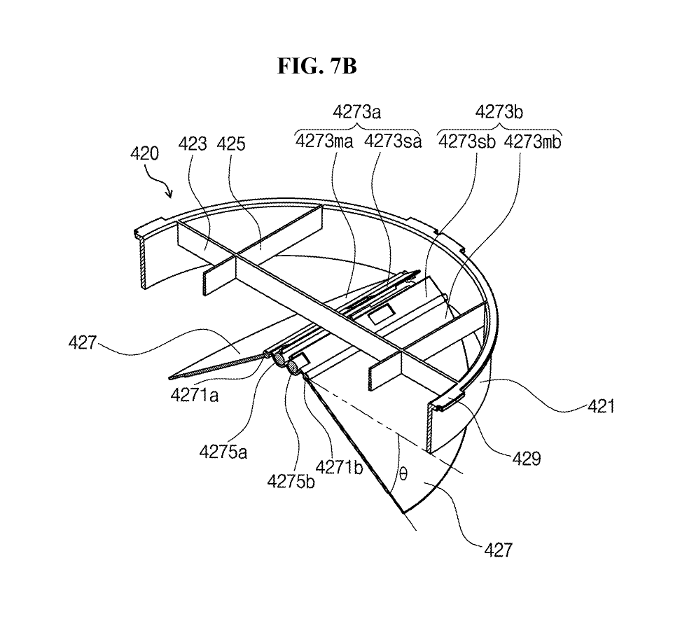

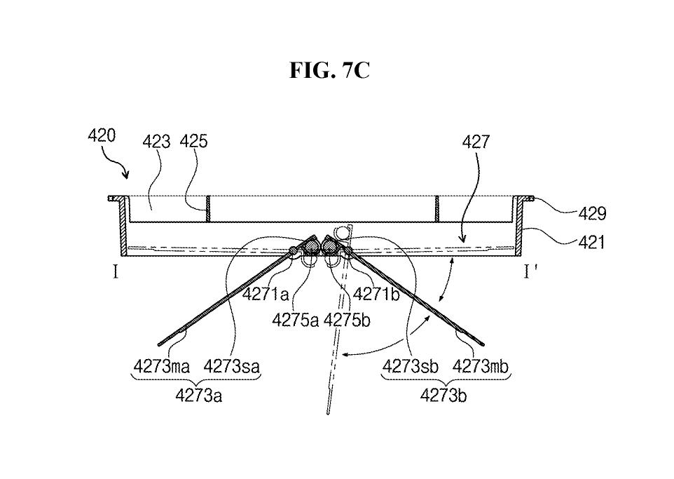

FIG. 6A is a perspective view showing the trapping net cover 420 in a closed state according to an exemplary embodiment of the present invention. FIG. 6B is a partial perspective view taken along a line I-I′ of FIG. 6A. FIG. 6C is a cross-sectional view taken along the line I-I′ of FIG. 6A. FIG. 7A is a perspective view showing the trapping net cover 420 in an opened state according to an exemplary embodiment of the present invention. FIG. 7B is a partial perspective view taken along a line II-IF of FIG. 7A. FIG. 7C is a cross-sectional view taken along the line II-IF of FIG. 7A.

Referring to FIGS. 6A to 6C and 7A to 7C, the trapping net cover 420 according to the exemplary embodiment of the present invention includes the body frame 421, the rib connected to the body frame 421, and the shutter part 427 mounted on the body frame 421.

The body frame 421 defines the overall shape of the trapping net 410, has a ring shape when viewed in a plan view (i.e., when viewed from the top to the bottom), and has a plate shape with a width in the vertical direction. The shape in the plan view of the body frame 421 corresponds to a circumference of the opening formed through the trapping net 410. Accordingly, in a case where the upper ring 412 of the trapping net 410 has a circular shape when viewed in a plan view, the body frame 421 has also a circular shape.

In the exemplary embodiment of the present invention, the body frame 421 has a shape similar to the upper ring 412 to be engaged with the upper ring 412 of the trapping net 410. In this case, an outer diameter of the body frame 421 may be equal to or slightly smaller than an inner diameter of the upper ring 412, and the body frame 421 may be coupled to the upper ring 412 such that an outer circumferential surface of the body frame 421 makes contact with an inner circumferential surface of the upper ring 412.

At least one rib is provided on the inner circumferential surface of the body frame 421 to maintain the shape and rigidity of the body frame 421.

The rib has a plate-bar shape having a width in the vertical direction (i.e., a first direction D1) and extending in a second direction D2 perpendicular to the first direction D1. Here, the second direction D2 corresponds to a direction crossing the body frame 421 along a horizontal direction. Accordingly, the rib has two end portions in the second direction D2, one end portion of the two end portions is connected to an area of the body frame 421, and the other end portion of the two end portions is connected to another area of the body frame 421. When viewed in a plan view, the rib may correspond to a chord of the circular shape of the body frame 421.

A plurality of ribs may be provided. In an exemplary embodiment of the present invention, when a plurality of the ribs are provided, the ribs may be arranged in the same direction. In addition, when a plurality of the ribs are provided, the ribs may be arranged in different directions. For instance, the ribs may include a plurality of first ribs 423 extending in the second direction D2 and a plurality of second ribs 425 extending in a third direction D3. The third direction D3 corresponds to the direction crossing the body frame 421 in the horizontal direction. An angle between the second direction D2 and the third direction D3 may have various values as long as the second and third directions D2 and D3 extend in different directions. In an exemplary embodiment of the present invention, the angle may be about 90 degrees. In the present exemplary embodiment, the angle of about 90 degrees will be described as a representative example. In a case where an angle between the first and second ribs 423 and 425 is about 90 degrees, the stress applied to the body frame 421 may be effectively distributed to the first and second ribs 423 and 425. However, in a case where the body frame 421 has an oval shape or other different shapes rather than the circular shape, the angle formed by the first rib 423 and the second rib 425 need not be about 90 degrees, and the angle may be changed within a range that maintains the rigidity of the body frame 421 as much as possible.

The number of the ribs may be differently determined depending on the particular exemplary embodiment. When the body frame 421 includes a material with a relatively high rigidity, the number of the ribs may be small, and when the body frame 421 includes a material with a relatively low rigidity, the number of the ribs may be large. In an exemplary embodiment of the present invention, for the convenience of explanation, two first ribs 423 and two second ribs 425 are shown.

The first rib 423 and the second rib 425 have a plate shape having a width in the vertical direction (i.e., the first direction DD. In an exemplary embodiment of the present invention, when assuming that the widths of the first rib 423 and the second rib 425 are respectively referred to as a first width W1 and a second width W2, the first width W1 of the first rib 423 and the second width W2 of the second rib 425 have values to allow the shutter part 427 described below to move as easily as possible. That is, the first width W1 of the first rib 423 and the second width W2 of the second rib 425 may have the values so as not to interrupt the movement of the shutter part 427. In an exemplary embodiment of the present invention, the first width W1 and the second width W2 may have values less than the width of the body frame 421, and in this case, the first width W1 and the second width W2 may have the same value as each other.

In an exemplary embodiment of the present invention, the body frame 421, the first rib 423, and the second rib 425 may be integrally formed with each other without being separated from each other.

The shutter part 427 is provided to the trapping net cover 420. The shutter part 427 opens or closes the upper portion of the trapping net 410 depending on the on/off of the air blowing part 20 (refer to FIGS. 2 and 4).

The shutter part 427 includes two shutters, i.e., a first shutter 4273a and a second shutter 4273b. The first shutter 4273a and the second shutter 4273b have a pair of semi-circular shapes to form one circle. When viewed in a plan view, the first shutter 4273a and the second shutter 4273b have the same radius as a radius of the body frame 421 to cover the circle of the body frame 421. When viewed in a plan view, a circumference of the first shutter 4273a is defined by an arc of one semi-circle of the circle and a chord that passes near a center of the circle, and a circumference of the second shutter 4273b is defined by an arc of the other semi-circle of the circle and a chord that passes near a center of the other circle. In this case, the arc of the first shutter 4273a and the arc of the second shutter 4273b face the inner circumferential surface of the body frame 421, and the chord of the first shutter 4273a and the chord of the second shutter 4273b face each other. The shutter part 427 and the inner circumferential surface of the body frame 421 are spaced apart from each other to be individually operable, but the insects do not pass through between the shutter part 427 and the inner circumferential surface of the body frame 421. In addition, the first shutter 4273a and the second shutter 4273b are spaced apart from each other to be individually operable, but the insects do not pass through between the first shutter 4273a and the second shutter 4273b.

A first rotating rod 4271a corresponding to a pivot axis is provided on the first shutter 4273a to allow the first shutter 4273a to rotate. The first rotating rod 4271a extends in a direction substantially parallel to the chord of the first shutter 4273a, and both ends of the first rotating rod 4271a are coupled to the body frame 421. The body frame 421 includes holes formed therethrough at positions facing each other, to which the first rotating rod 4271a is coupled. The holes are located adjacent to a lower end portion of the body frame 421. The first rotating rod 4271a is inserted into the holes.

Due to the first rotating rod 4271a, a first main wing 4273ma and a first sub-wing 4273sa, which are divided into different areas from each other, are respectively disposed at both sides of the first shutter 4273a. The first main wing 4273ma has a shape of a segment of a circle, and the first rotating rod 4271a corresponds to a chord of the segment of the circle. The first main wing 4273ma has the area greater than that of the first sub-wing 4273sa. The first sub-wing 4273sa has an elongated rectangular shape and is disposed adjacent to the first main wing 4273ma such that the first rotating rod 4271a is disposed between the first main wing 4273ma and the first sub-wing 4273sa.

A first weight 4275a is provided on the first sub-wing 4273sa. The first weight 4275a is provided on the first sub-wing 4273sa having the small area to compensate for a difference in weight from the first main wing 4273ma having the large area. The first weight 4275a may have a weight corresponding to the weight difference between the first main wing 4273ma and the first sub-wing 4273sa or more.

Accordingly, the first shutter 4273a may be positioned in a direction (a plane surface defined by the second direction D2 and the third direction D3) in which the first shutter 4273a horizontally crosses the body frame 421 with the first rotating rod 4271a disposed therebetween as long as no extra force is applied to the first shutter 4273a.

In the same way, a second rotating rod 4271b is provided on the second shutter 4273b, and a second main wing 4273mb and a second sub-wing 4273sb are disposed with the second rotating rod 4271b disposed therebetween. A second weight is provided on the second sub-wing 4273sb, and the second shutter 4273b may be positioned in a direction (the plane surface defined by the second direction D2 and the third direction D3) in which the second shutter 4273b horizontally crosses the body frame 421 with the second rotating rod 4271b disposed therebetween as long as no extra force is applied to the second shutter 4273b.

However, in the case where the air is supplied to the shutter part 427 by the fan 220 of the air blowing part 20, the shutter part 427 is rotated by a pressure caused by the air, and thus the trapping net 410 is opened.

Referring to FIGS. 7A and 7B, when the fan 220 of the air blowing part 20 is operated, the air flows to the trapping net 410 from the air blowing part 20, and the pressure caused by the flow of the air is applied to the shutter part 427. In this case, since the area of the first main wing 4273ma and the second main wing 4273mb is greater than the area of the first sub-wing 4273sa and the second sub-wing 4273sb, the pressure caused by the air is mainly applied to the first and second main wings 4273ma and 4273mb, and as a result, the shutter part 427 is rotated about the first and second rotating rods 4271a and 4271b as a pivot center at a predetermined angle (θ) to move obliquely with respect to the horizontal direction, thereby opening the shutter part 427.

FIG. 7C shows an original position of the shutter part 427 and positions at which the shutter part 427 is obliquely located with respect to the horizontal direction due to the movement of the shutter part 427. In the present exemplary embodiment, the first and second shutters 4273a and 4273b may move independently of each other and may be rotated at the same angle as each other or different angles from each other. In particular, each of the first and second shutters 4273a and 4273b may be opened downward with respect to the horizontal direction at a predetermined angle, and the angle may be within a range from about zero (0) degrees to about 180 degrees.

In an exemplary embodiment of the present invention, the first shutter 4273a and the second shutter 4273b may be opened symmetrically or asymmetrically with respect to each other. For example, the first shutter 4273a and the second shutter 4273b may be opened at an angle of about 45 degrees or about 90 degrees. As another example, the first shutter 4273a may be opened at an angle of about 95 degrees, and the second shutter 4273b may be opened at an angle of about 85 degrees.

According to exemplary embodiments of the present invention, regardless of whether the first shutter 4273a and the second shutter 4273b are opened symmetrically or asymmetrically, since the shutter part 427 is opened downward with respect to the horizontal direction without angle restrictions, the shutter part 427 allows a maximum flow passage to be ensured according to the pressure of the air, which is applied thereto. When the flow passage becomes wider, a flow amount that is able to be processed increases, and thus, more air travels to the trapping part 40. The flow of the air eventually leads to improvement in trapping ability.

In an exemplary embodiment, the holes into which the first and second rotating rods 4271a and 4271b are inserted are located at the lower end portion of the body frame 421, and the first and second ribs 423 and 425 are located at the upper end portion of the body frame 421. The first and second ribs 423 and 425 are required to be spaced apart from the first and second sub-wings 4273sa and 4273sb without interrupting the rotation of the shutters in some areas, and to this end, the body frame 421 may have a width greater than the first width W1 and the second width W2 such that the holes for the first and second rotating rods 4271a and 4271b are sufficiently spaced apart from the first and second ribs 423 and 425. Accordingly, although the first and second sub-wings 4273sa and 4273sb are rotated with respect to the first and second rotating rods 4271a and 4271b, the rotation of the first and second sub-wings 4273sa and 4273sb is not interrupted.

According to the above-described exemplary embodiments, the insect trap according to an exemplary embodiment of the present invention includes the trapping net cover 420 mounted on the trapping net 410 to cover the trapping net 410, and thus, the trapped insects may be prevented from being lost or escaped. Particularly, since the trapping net cover 420 is opened only when the fan 220 of the air blowing part 20 is operated, the air is continuously supplied to the downward direction from the top while the fan 220 of the air blowing part 20 operates. As a result, it is difficult for the insects to escape from the entrance of the trapping net 410. In addition, when the fan 220 of the air blowing part 20 is not operated, the pressure caused by the air is eliminated, and the shutter 427 is automatically closed. As a result, the insects may not escape from the trapping net 410.

Further, according to an exemplary embodiment of the present invention, the insects are prevented from being lost or escaped when the insects are removed from the trapping part 40. That is, according to an exemplary embodiment of the present invention, since the assembly of the trapping net 410 and the trapping net cover 420 is separated from the housing 30 while being in the closed state, the trapped insects may not be lost or escaped. According to a conventional insect trap, since only the trapping net 410 is separated from the housing 30, the trapped insects are escaped or lost through the upper portion of the trapping net 410.

The trapping net cover 420 according to an exemplary embodiment of the present invention may have various shapes as long as the shape of the trapping net cover 420 meets the present inventive concepts. In the following exemplary embodiments, different features from those of the above-described exemplary embodiments will be mainly described in order to avoid redundancy. Unexplained portions are similar those of the above-described exemplary embodiments.

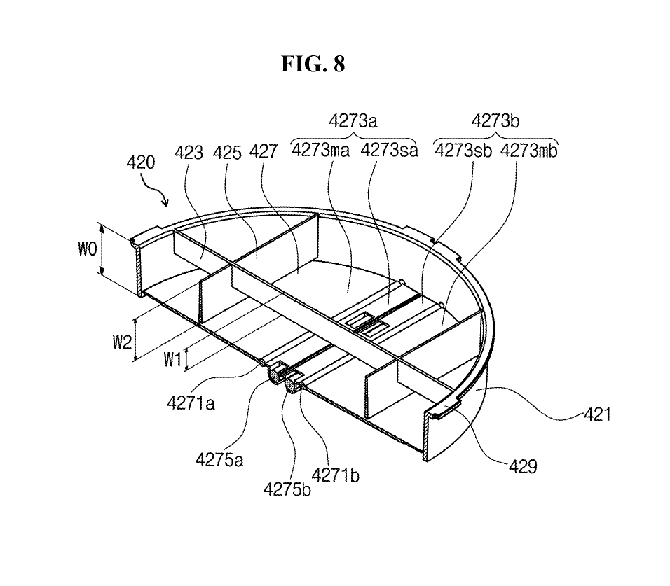

FIG. 8 is a partial perspective view showing a cross-section of an insect trap according to another exemplary embodiment of the present invention.

Referring to FIG. 8, a first rib 423 and a second rib 425 may have different widths from each other to allow one of the first and second ribs 423 and 425 to serve as a limiter that restricts a rotation angle of a shutter part 427.

In a case where the shutter part 427 is rotated upward with respect to a horizontal direction, an opening of a trapping net 410 is opened again. Accordingly, it is necessary to restrict the upward rotation of the shutter part 427. In the present exemplary embodiment, a second width W2 of the second rib 425 is greater than a first width W1 of the first rib 423, and thus, the second rib 425 is used as the limiter that prevents the shutter part 427 from being rotated upward.

In other words, the second rib 425 is disposed on a movement path in which the shutter part 427 is rotated to prevent the shutter part 427 from being opened upward again after passing the horizontal plane. To this end, the second rib 425 may be substantially parallel to first and second rotating rods 4271a and 4271b that are the pivot center. That is, since the first and second rotating rods 4271a and 4271b extend in the third direction D3, the second rib 425 may also extend in the third direction D3.

However, the first rib 423 may be sufficiently spaced apart from a first sub-wing 4273sa and a second sub-wing 4273sb so as not to interrupt the rotation of the first sub-wing 4273sa and the second sub-wing 4273sb.

In the present exemplary embodiment, since the shutter part 427 is prevented from being rotated upward with respect to the horizontal direction, it is not required to maintain a balance of weight so that the shutter part 427 is always located on a horizontal plane. Therefore, in the present exemplary embodiment, first and second weights 4275a and 4275b coupled to the shutter part 427 may be heavier than first and second main wings 4273ma and 4273mb. The first and second main wings 4273ma and 4273mb make contact with the second rib 425 by the first and second weights 4275a and 4275b as long as no extra force by an air blowing part 20 is applied, and the trapping part 40 is in the closed state.

According to an exemplary embodiment of the present invention, the insect trap uses one of the ribs as the limiter that restricts the rotation angle of the shutter, and the shape of the rib may be changed in various ways.

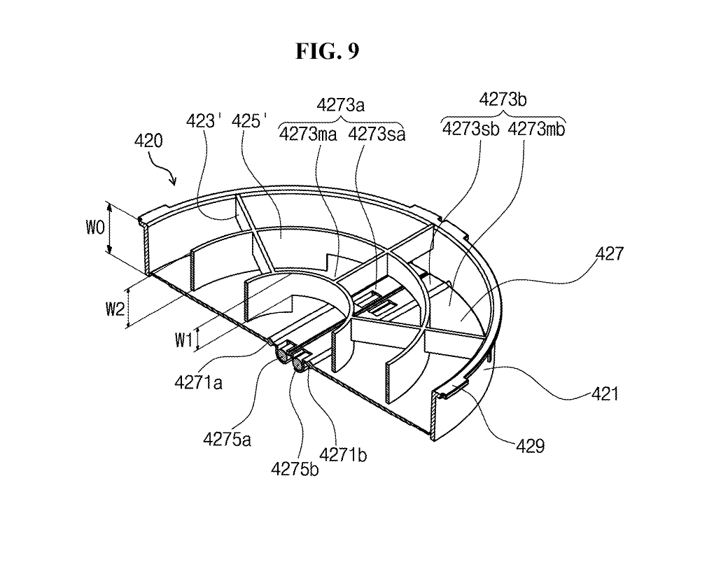

FIG. 9 is a partial perspective view showing a cross-section of an insect trap according to another exemplary embodiment of the present invention.

Referring to FIG. 9, a first rib 423′ crossing a body frame 421 when viewed in a plan view and a second rib 425′ having a circular shape may be provided at the body frame 421.

A plurality of the first ribs 423′ may be provided, and the first ribs 423′ may be arranged radially from a center of the body frame 421 when viewed in a plan view. In the present exemplary embodiment, one end of the first rib 423′ may be disposed at a center of circle, and the other end of the first rib 423′ may be connected to the body frame 421. However, as shown in FIG. 9, since a portion of the first rib 423′ is removed, the one end of the first rib 423′ may be disposed at a predetermined position in the body frame 421, and only the other end of the first rib 423′ may be connected to the body frame 421.

The second rib 425′ may be provided to form a concentric circle with the body frame 421. The second rib 425′ may be provided in singular or plural number, and two second ribs 425′ may be used as shown in FIG. 9.

In the present exemplary embodiment, the first and/or second ribs 423′ and 425′ may have different widths from each other depending on areas. The first and/or second ribs 423′ and 425′ may have the widths required to be spaced apart from first and second sub-wings 4273sa and 4273sb in a predetermined area, thereby not interrupting the rotation of the shutter part 427, especially the first and second sub-wings 4273sa and 4273sb.

Accordingly, as shown in FIG. 9, the first and second ribs 423′ and 425′ disposed in areas near first and second rotating rods 4271a and 4271b, in which the first and second sub-wings 4273sa and 4273sb are rotated, may have a relatively narrow first width W1. The first and second ribs 423′ and 425′ disposed in areas, in which first and second main wings 4273ma and 4273mb are rotated, away from the areas in which the first and second sub-wings 4273sa and 4273sb are rotated, may have a relatively wide second width W2 to serve as a limiter that prevents the first and second main wings 4273ma and 4273mb from being rotated upward.

As described in the present exemplary embodiment, the first and second ribs 423′ and 425′ may be manufactured in various shapes to maintain the rigidity of the body frame 421 and to control the rotation angle of the shutter part 427.

According to an exemplary embodiment of the present invention, the insect trap may employ other components as the limiter to partially restrict the rotation angle of the shutter.

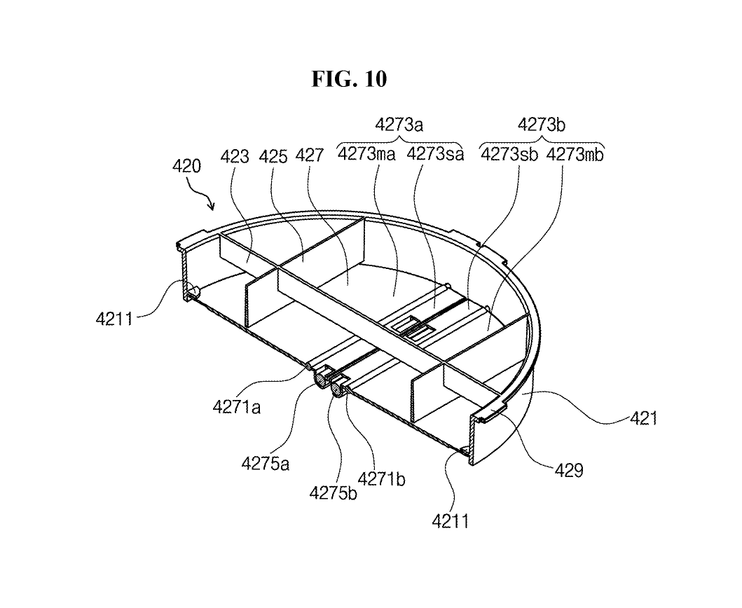

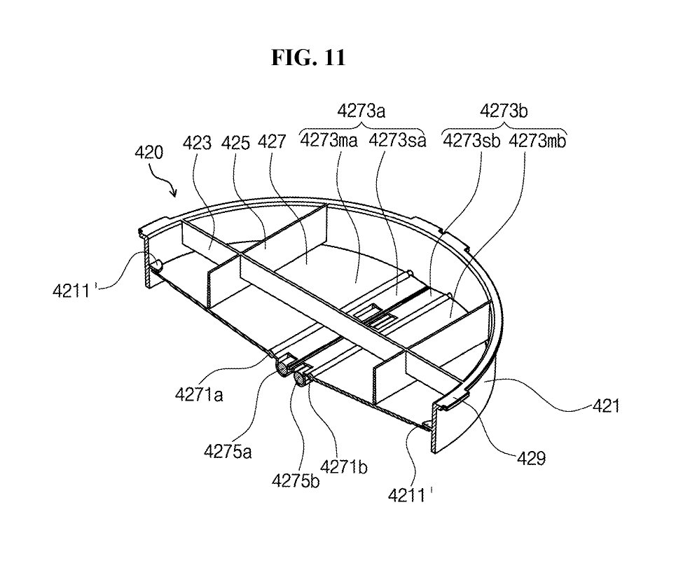

FIGS. 10 and 11 are partial perspective views showing a cross-section of insect traps according to another exemplary embodiment of the present invention.

Referring to FIG. 10, a body frame 421 may include a rotation limiter 4211 to partially restrict the rotation angle of a shutter part 427.

The rotation limiter 4211 has a protrusion shape protruding from an inner circumferential surface of the body frame 421. The rotation limiter 4211 may have a simple semi-circular or rectangular shape, and the shape and size of the rotation limiter 4211 should not be particularly limited as long as the rotation limiter 4211 prevents first and second shutters 4273a and 4273b from being rotated upward.

The rotation limiter 4211 is disposed on the body frame 421 to correspond to a horizontal position of the shutter part 427 in the closed state. An upper surface of the shutter part 427 makes contact with a lower surface of the rotation limiter 4211, and thus, the shutter part 427 is prevented from being rotated upward. In this case, the upper surface of the shutter part 427 is substantially parallel to the horizontal direction.

However, the position of the rotation limiter 4211 need not be limited to the position at which the upper surface of the shutter part 427 is completely parallel to horizontal direction, and the same structure is applied in the case where the second rib 425 serves as the limiter. That is, as shown in FIG. 10, the rotation limiter 4211 may be disposed slightly above the horizontal direction. The shutter part 427 may be slightly more upwardly rotated. However, even though a gap is generated by the upward rotation of the shutter 427, the position of the rotation limiter 4211 may be changed within a range that the trapped insects are difficult to escape through the gap.

In an exemplary embodiment of the present invention, the rotation angle of the shutter may be controlled by various ways instead of changing the shape of the rib or employing the rotation limiter.

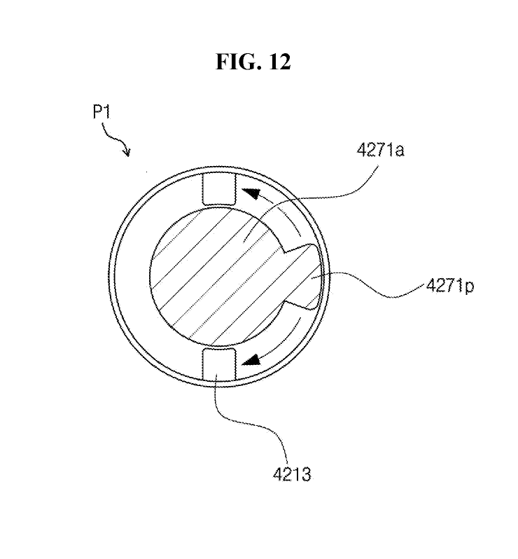

FIG. 12 is a plan view showing the insect trap employing a structure that controls the rotation angle of the rotating rod rather than the shutter according to an exemplary embodiment of the present invention. FIG. 12 shows a portion corresponding to a portion P1 of FIG. 6A.

Referring to FIG. 12, the structure may be formed in the first rotating rod 4271a and the body frame 421 coupled to the first rotating rod 4271a to control the rotation angle of the first rotating rod 4271a.

The body frame 421 includes the holes into which the first rotating rod 4271a is inserted, and the first rotating rod 4271a may be rotated about a center axis thereof as a pivot axis after being inserted into the holes. In this case, the first rotating rod 4271a is provided with a step jaw 4271p protruded in one direction from the first rotating rod 4271a. The body frame 421 includes at least one, preferably a pair of pivot limiters 4213 to restrict a rotation angle and a position of the step jaw 4271p. The step jaw 4271p is rotated about the center axis of the first rotating rod 4271a in an area defined and restricted by the pivot limiter 4213.

In the present exemplary embodiment, the shape and number of the step jaws 421′7p and the shape and number of the pivot limiters 4213 may be changed in various ways.

Accordingly, the rotation angle of the shutter part may be controlled by setting the number and position of the pivot limiters 4213. As described in the present exemplary embodiment, when the rotation angle of the first rotating rod 4271a is controlled, the above-described other limiters, for example, the rotation limiter 4211 or the limiter using the second rib 425, may or may not be formed.

In an exemplary embodiment of the present invention, the shutter part may have other shapes as long as the shutter part is able to be opened or closed by the on/off of the air blowing part.

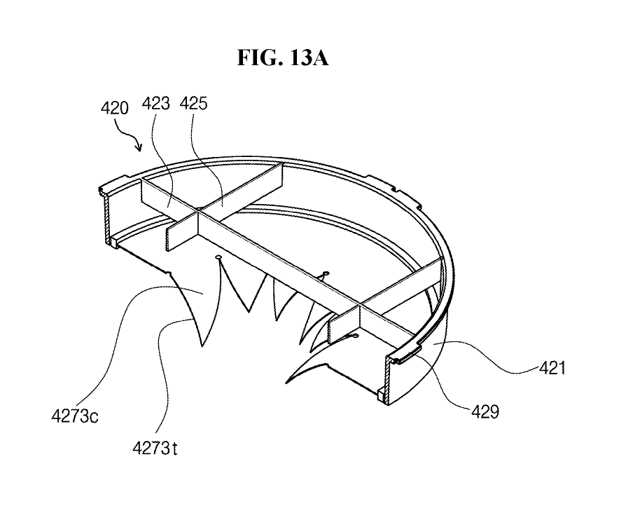

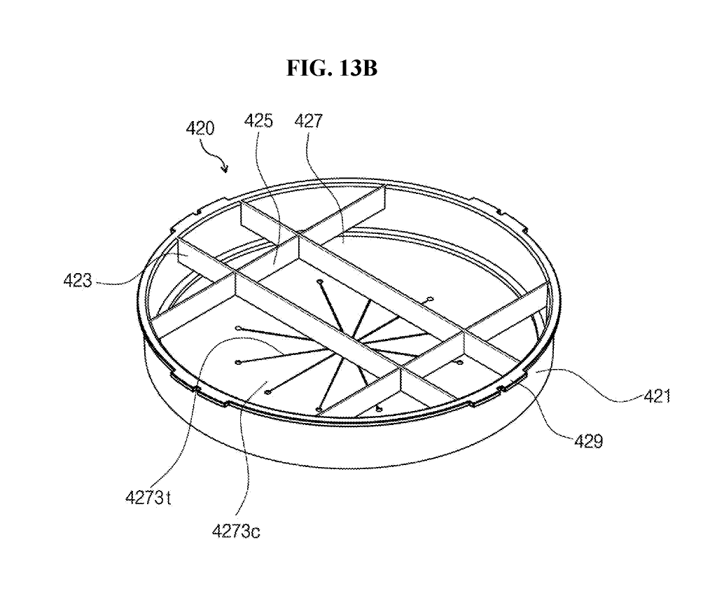

FIGS. 13A and 13B show a trapping net cover 420 according to another exemplary embodiment of the present invention. FIG. 13A is a perspective view showing the trapping net cover 420 of which a shutter is in an opened state, and FIG. 13B is a perspective view showing the trapping net cover 420 of which the shutter is in a closed state.

Referring to FIGS. 13A and 13B, the trapping net cover 420 according to the present exemplary embodiment includes a body frame 421 and a shutter part 427 coupled to a lower end portion of the body frame 421.

In the present exemplary embodiment, the shutter part 427 includes a plurality of shutters cut along a cutting line 4273t. The cutting line 4273t is provided in a radial form from a center of the body frame 421 when viewed in a plan view.

The shutter part 427 includes a material having flexibility and elasticity and is bent downward when the pressure caused by the flow of the air is applied thereto from the upper portion of the body frame 421, thereby opening the shutters. When the pressure caused by the flow of the air is eliminated, the shutter part 427 is closed again by the elasticity.

In the present exemplary embodiment, the shutter part 427 may be integrally formed as a single unit. In addition, the shutter part 427 may be coupled to the body frame 421 after being separately formed or may be integrally formed with the body frame 421.

In an exemplary embodiment of the present invention, although not shown in figures, an insecticide dispenser may be provided to the cover, housing, and trapping part to kill the trapped insects. The insecticide dispenser includes an insecticide and sprays the insecticide to prevent the insects trapped in the trapping part from being lost. A shape and a position of the insecticide dispenser should not be particularly limited.

Although not shown in figures, the insect trap according to an exemplary embodiment of the present invention may further include components for the effects of sterilization, purification, deodorization, etc., in addition to the trapping and insecticidal effects. For example, the insect trap according to an exemplary embodiment of the present invention may include a photocatalytic material with the sterilization effect. In this case, although not shown in figures, a heater (e.g., a hot wire) may be further provided to the cover, housing, and trapping part. In a case of an insect trap using a photocatalytic reaction with respect to an ultraviolet light, the trapping effect may be maximized by increasing an ambient temperature and increasing reactivity between the ultraviolet light and the photocatalytic material.

In addition, in a case where the heater is mounted on the insect trap, insects that prefer high temperature may be additionally attracted, and the trapped insects are dried by the high temperature, thereby certainly killing the trapped insects.

Further, the driver of the insect trap according to an exemplary embodiment of the present invention may further include a control part that performs various functions, such as emitting different wavelengths depending on insects, controlling the amount of the emitted light depending on the amount of insects, and controlling on/off or flash degree of the light source.

In addition, the insect trap according to an exemplary embodiment of the present invention may further include a light amount detecting sensor, and the light amount detecting sensor may be used to control the amount of light from the light source part by detecting an amount of external light or may be used to determine the timing of replacing the light source part.

Although certain exemplary embodiments have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An insect trap comprising:
a light source part configured to emit a light;
a fan disposed under the light source part;
a housing accommodating the fan; and
a trapping part disposed under the fan and coupled to the housing, the trapping part comprising:
a trapping net comprising an opening facing the fan;
a body frame coupled to the trapping net;
at least one first rib crossing the body frame; and
a shutter part coupled to the body frame to be spaced apart from the first rib and opened or closed depending on an operation of the fan.

2. The insect trap of claim 1, wherein the housing has a cylindrical shape extending in a first direction.

3. The insect trap of claim 2, wherein the first rib has a first width in the first direction and extends in a second direction substantially perpendicular to the first direction.

4. The insect trap of claim 3, further comprising a one second rib having a second width in the first direction and extending in a third direction crossing the second direction.

5. The insect trap of claim 4, wherein the second direction is substantially perpendicular to the third direction.

6. The insect trap of claim 4, wherein the first width is equal to the second width.

7. The insect trap of claim 4, wherein the second width is greater than the first width.

8. The insect trap of claim 4, wherein the body frame has a circular shape when viewed in a plan view, and the second rib has a concentric shape with a radius different from that of the body frame.

9. The insect trap of claim 4, wherein the shutter part comprises:
a first rotating rod crossing the body frame;
a second rotating rod crossing the body frame;
a first shutter coupled to the first rotating rod and having a plate shape;
a second shutter coupled to the second rotating rod and having a plate shape;
a first weight disposed at one side portion of the first shutter; and
a second weight disposed at one side portion of the second shutter,
wherein the first and second shutters are configured to be independently rotated about the first and second rotating rods, respectively.

10. The insect trap of claim 9, wherein a longitudinal direction of the first and second rotating rods corresponds to the second direction.

11. The insect trap of claim 9, wherein each of the first and second shutters comprises a main wing and a sub-wing, which face each other with the first rotating rod disposed therebetween, and each of the first and second weights is coupled to the sub-wing.

12. The insect trap of claim 11, wherein the sub-wing of the first and second shutters is spaced apart from the first rib.

13. The insect trap of claim 11, wherein the main wing contacts the second rib when the fan is not operated.

14. The insect trap of claim 11, wherein the sub-wing is substantially parallel to the first direction and faces the fan when the fan is not operated.

15. The insect trap of claim 9, wherein the first and second shutters are closed when the fan is not operated and opened at an inclined angle when the fan is operated.

16. The insect trap of claim 9, wherein the trapping part further comprises at least one limiter protruded from an inner circumferential surface of the body frame and configured to restrict a movement of the first and second shutters.

17. The insect trap of claim 9, wherein each of the first and second rotating rods comprises a step jaw protruded therefrom, and the body frame comprises a rotation limiter configured to restrict a rotation of the step jaw.

18. The insect trap of claim 1, further comprising a cover coupled to the housing to cover the light source part.

19. The insect trap of claim 18, further comprising an insecticide dispenser provided on at least one of the light source part, the housing, the cover, the fan, and the trapping net and configured to spray an insecticide.

20. The insect trap of claim 18, further comprising a heater provided on at least one of the light source part, the housing, the cover, the fan, and the trapping net and configured to radiate a heat.

21. The insect trap of claim 1, wherein the body frame comprises a first coupling part configured to be coupled to the trapping net.

22. The insect trap of claim 21, wherein the first coupling part is an insertion protrusion protruded from the body frame, and the trapping net comprises an insertion recess into which the insertion protrusion is inserted.

23. The insect trap of claim 21, wherein the body frame comprises a second coupling part configured to be coupled to the housing.

24. The insect trap of claim 23, wherein the second coupling part is an insertion protrusion protruded from the body frame, and the housing comprises an insertion recess into which the insertion protrusion is inserted.

25. The insect trap of claim 23, wherein the second coupling part is a spiral protrusion protruded from the body frame, and the trapping net is rotatably inserted into the housing.
